(19) United States
(12) Patent Application Publication
(10) Pub. No.: US 2018/0247345 A1
(43) Pub. Date: Aug. 30, 2018

(54) Universal Value Equivalent Emblems

(71) Applicants: Jeff Van Le, Panorama City, CA (US); Natalie Huynh Le, Panorama City, CA (US)

(72) Inventors: Jeff Van Le, Panorama City, CA (US); Natalie Huynh Le, Panorama City, CA (US)

(21) Appl. No.: 15/444,577

(22) Filed: Feb. 28, 2017

(51) Int. Cl. G06Q 30/02

(52) U.S. Cl. CPC G06Q 30/0278

(57) ABSTRACT

Presented is a computer-implemented system and method for converting between a financial value and a Universal Value Equivalent Emblem for Fashion Designs, Fashion Accessories, and Home Furnishings.

### BACKGROUND

Each and every Fashion Design, Fashion Accessory, or Home Furmshmg existed in this world has some form of financial value. Some people tend to use the financial value to brag their belongings, such as Fashion Designs, Fashion Accessories, and Home Furnishings, especially when their belongings come with high financial values. Unfortunately, the financial values of products such as a Fashion Design, Fashion Accessory, or Home Furnishing either is marked, for example, with a price tag or has to be verbally announced. It is nearly impossible to identify the financial value of a Fashion Design, Fashion Accessory, or Home Furnishing after the price tag has been removed. As such, it is necessary to announce the financial value of such a Fashion Design, Fashion Accessory, or Home Furnishing if the owner warns others to know of its financial value. Thus, the announcement would sound snobbish. The Universal Value Equivalent Emblem of the present invention makes it possible to brag the financial value of a Fashion Design, Fashion Accessory, or Home Furnishing without being snobbish; and it is also stylish and subtle.

Presenting is a useful computer-implemented system and method for convening between a financial value and a Universal Value Equivalent Emblem for Fashion Designs. Fashion Accessories, and Home Furnishings. This useful computer-implemented system and method can convert a financial value into a Universal Value Equivalent Emblem; and vice versa. The useful computer-implemented system and method allows a Universal Value Equivalent Emblem to represent a certain financial value or range of financial values. Thus, enabling for the conversion.

### BRIEF DESCRIPTIONS OF THE ILLUSTRATIONS

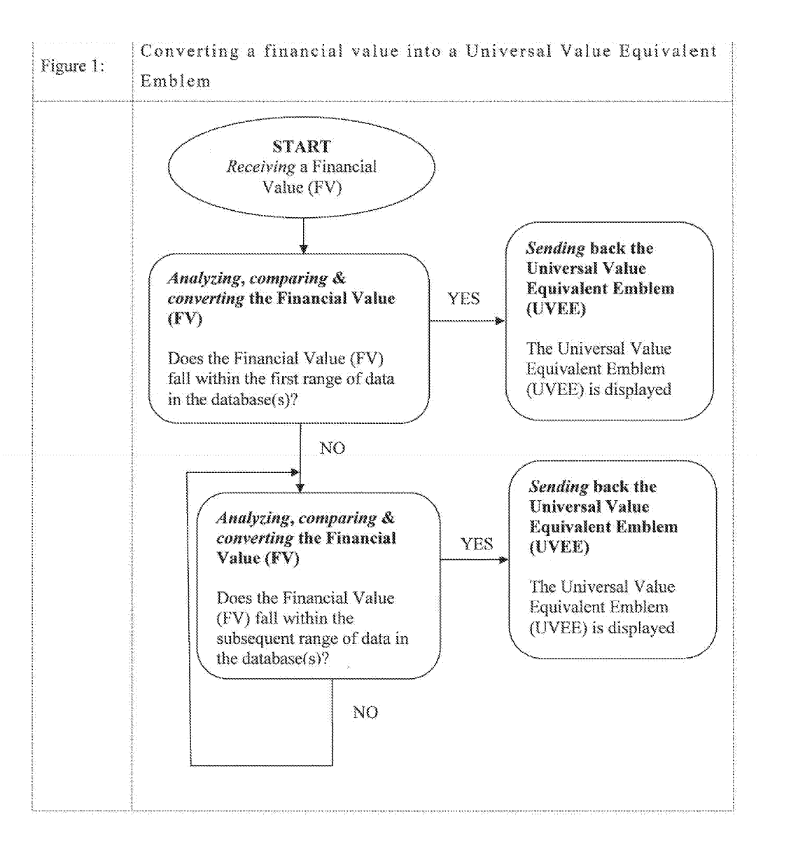

FIG. 1 shows a computer-implemented system and method for convening a financial value into a Universal Value Equivalent Emblem:

Receive a financial value from an external source. The external, source can be from a scanning device or simply by data entry, but by no means limit this present invention only to the external sources described wherein;

Compare and analyze such, a financial value against each and every relevant data in the database(s) until it finds the appropriate one;

Convert such a financial value into the particular Universal Value Equivalent Emblem that has been specifically paired with such a financial value;

Send back such a paired Universal Value Equivalent Emblem information.

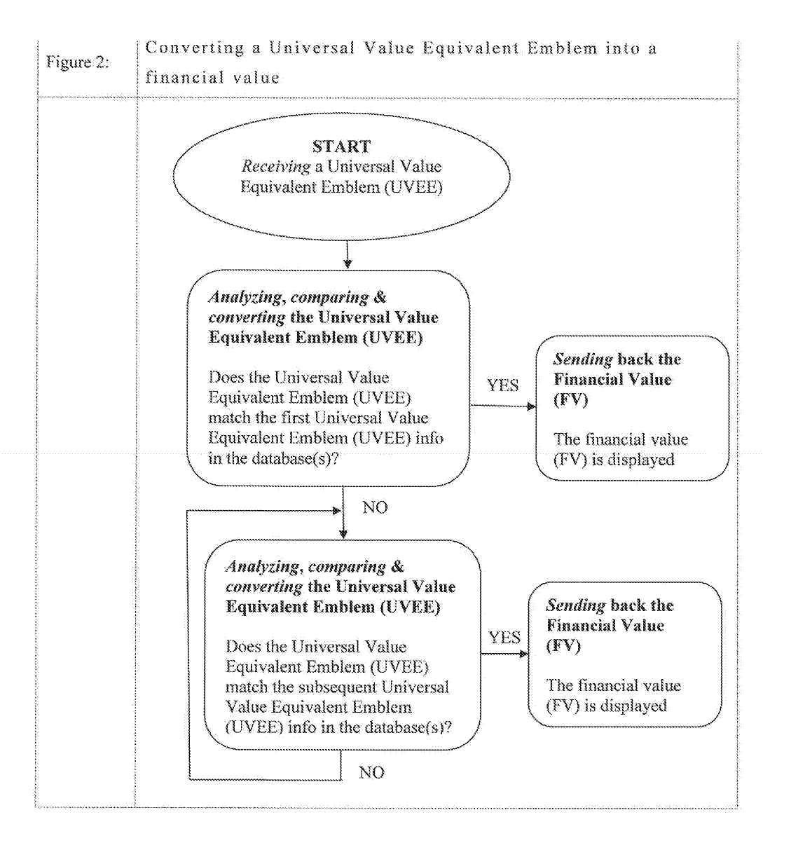

FIG. 2 shows a computer-implemented system and method for converting a Universal Value Equivalent Emblem into a financial value:

Receive a Universal Value Equivalent Emblem from an external source. The external source can be from a scanning device or simply by data entry, but by no means limit this present invention only to the external sources described wherein;

Compare and analyze such a Universal Value Equivalent Emblem against each and every relevant data in the database(s) until It finds the appropriate one;

Convert such a Universal Value Equivalent Emblem into the particular financial value that has been specifically paired with such a Universal Value Equivalent Emblem;

Send back such a paired financial value information.

What is claimed is:

1. A computer-implemented system and method for converting a financial value into a Universal Value Equivalent Emblem for Fashion Designs, Fashion Accessories, and Home Furnishings, comprising the steps of:
Receiving a financial value from an external source such as a scanning device or by data entry;
Comparing and analyzing such a financial value against relevant data in the database(s);
Converting such a financial value into the particular Universal Value Equivalent Emblem that has been specifically paired with such a financial value;
Sending back such a paired Universal Value Equivalent Emblem information.

2. A computer-implemented system and method for converting a Universal Value Equivalent Emblem into a financial value for Fashion Designs, Fashion Accessories, and Home Furnishings, comprising the steps of:
Receiving a Universal Value Equivalent Emblem from an external source such as a scanning device or by data entry;
Comparing and analyzing such a Universal Value Equivalent Emblem against relevant data in the database(s);
Converting such a Universal Value Equivalent Emblem into the particular financial value that has been specifically paired with such a Universal Value Equivalent Emblem;
Sending back such a paired financial value information.
